(19) United States
(12) Patent Application Publication
(10) Pub. No.: US 2008/0068628 A1
(43) Pub. Date: Mar. 20, 2008

(54) Image Processing Apparatus and Image Processing Method

(75) Inventor: Kenji DOKUNI, Kyoto-shi (JP)

Correspondence Address: HOGAN & HARTSON L.L.P., 1999 AVENUE OF THE STARS, SUITE 1400, LOS ANGELES, CA, 90067, US

(73) Assignee: MURATA MACHINERY, LTD., Kyoto-shi (JP)

(21) Appl. No.: 11/857,936

(22) Filed: Sep. 19, 2007

(30) Foreign Application Priority Data
Sep. 20, 2006 (JP) 2006-253794
Sep. 20, 2006 (JP) 2006-253795

(51) Int. Cl. G06K 15/00

(52) U.S. Cl. 358/1.9

(57) ABSTRACT

An image processing apparatus includes a color table and a black and white (monochrome) table stored in a table storage unit. Image data is inputted to a data input unit. A table processing unit replaces a density value in at least a part of the three primary colors of the color table with a density value of the black and white table, and generates a temporary table by replacing all density values in other parts of the three primary colors and black with zero. A table retaining unit temporarily retains the temporary table. A data conversion unit converts the inputted image data into print data using the temporarily-retained temporary table. A data output unit outputs the converted print data.

### CROSS-REFERENCE TO RELATED APPLICATIONS

This application claims priority under 35 U.S.C. 119 to Japanese Patent Application No. 2006-253794, filed on Sep. 20, 2006, and Japanese Patent Application No. 2006-253795, filed on Sep. 20, 2006, which applications are hereby incorporated by reference in their entireties.

### BACKGROUND OF THE INVENTION

1. Field of the Invention

The present invention relates to an image processing apparatus which converts image data into print data, and particularly to an image processing apparatus which utilizes a look-up table to convert full-color image data into full-color print data or black and white print data.

2. Description of the Related Art

Conventionally, there has been an image processing apparatus which converts image data into print data. The image processing apparatus has been implemented, for example, in the forms of a printer driver function installed as application software in a personal computer, a printer driver mounted as hardware on the personal computer, a printer controller mounted as software in the printer device, and a printer controller mounted as hardware on the printer driver.

For example, one conventional image processing apparatus includes a table storage unit, a table retaining unit, a data input unit, a data conversion unit, a data output unit, an instruction unit, and table processing unit. The table storage unit stores a plurality of look-up tables. The table retaining unit temporarily retains a look-up table. Image data is inputted to the data input unit. The data conversion unit converts the inputted image data into print data using the temporarily-retained look-up table. The data output unit outputs the converted print data. At least print instructions for a color image and a black and white image are selectively inputted to the instruction input unit. The table processing unit obtains a look-up table from the table storage unit corresponding to the inputted print instruction and stores the look-up table in the table retaining unit.

Full-color image data includes one lightness value and a plurality of color values. For example, the full-color image data may be generated by utilizing a color space expressed in the form of (L, a, b).

Full-color print data includes density values of three primary colors and black. The full-color print data may be generated by utilizing the color space expressed in the form of CMYK (Cyan, Magenta, Yellow, and Black). Black and white print data includes a black density value.

When a print instruction for a color image is inputted, the table processing unit obtains a color table from the table storage unit and stores the color table in the table retaining unit. When a print instruction for a black and white image is inputted, the table processing unit obtains a black and white table (monochrome table) from the table storage unit and stores the black and white table in the table retaining unit.

In the conventional image processing apparatus, when a user inputs a print instruction for a color image, full-color print data is generated from the full-color image data. When a user inputs a print instruction for a black and white image, black and white print data is generated from the full-color image data. Then, the print data is transmitted from the image processing apparatus to a color printer, which prints out a color image or a black and white image.

In the conventional image processing apparatus, full-color image data is converted properly and simply into full-color print data and black and white print data by utilizing a look-up table.

Although the conventional image processing apparatus can generate full-color print data and black and white print data from full-color image data by utilizing a look-up table there are various other needs in connection with a print data output mode.

For example, there is a need for generating monochrome print data except for black from full-color image data. For this end, there has been known an image processing apparatus which has a dedicated table as one of the look-up tables to convert full-color image data into monochrome print data.

However, in this apparatus, it is necessary to store the dedicated look-up table to print the monochrome image or the specific-color image. Because a large capacity is required for storage of a look-up table, it is not preferable to increase the number of look-up tables.

For example, it can be assumed that monochrome image print data is generated by one of cyan, magenta, yellow, cyan+magenta, cyan+yellow, magenta+yellow, and cyan+magenta+yellow. In such cases, because a large number of large-capacity look-up tables are required, the data capacity used to store the look-up tables is increased.

In order that any color can be selected as the specific color, a number of look-up tables as many as the number of specific colors is required. This is not practical because a huge number of large-capacity look-up tables are required.

There is also a need for generating two-color print data from full-color image data. For example, full-color image data whose color space is RGB (Red, Green, and Blue) can be converted into two-color print data.

More specifically, when a special image including black and magenta is printed out, for example, RGB image data is converted into CMYK print data to output only print data including black and the specific color of magenta.

Additionally there has been known a technique in which RGB image data is converted into CMYK print data to output print data including the specific color of magenta, and the print data except for the specific color is outputted in a second specific color such as black.

In the conventional image processing apparatus, wasteful processing of specific-color image data as full-color image data can be removed when an original printed in the specific color is duplicated. However, this will not reflect color components except for the selected specific color on the print data. Therefore, reproducibility of the color image is remarkably lowered.

Frequently, full-color image data is actually formed by black and white text and a full-color pattern. For image data including black and white text and a full-color pattern, there is a need to print the black and white portion in black and the color portion in specific color. However, the conventional image processing apparatus does not respond to the need.

### SUMMARY OF THE INVENTION

In view of the foregoing, a first object of the present invention is to provide an image processing apparatus and method, wherein a look-up table for converting full-color image data into mono-color print data is generated from already-existing full-color and black and white (monochrome) tables.

A second object of the present invention is to provide an image processing apparatus and method, wherein a look-up table for converting a color portion or a black portion of full-color image data into print data in a specific color is generated from an already-existing look-up table.

An image processing apparatus according to a first aspect of the present invention includes a table storage unit, data input unit, a table processing unit, a table retaining unit, a data conversion unit, and a data output unit. The table storage unit stores a color table for converting full-color image data including one lightness value and a plurality of color values into full-color print data including density values of three primary colors and black, and a black and white table (monochrome table) for converting the full-color image data into black and white print data including a density value of black. Image data is inputted to the data input unit. The table processing unit replaces a density value in at least a part of the three primary colors of the color table with a density value of the black and white table while generating a temporary table by replacing all the density values in other parts of the three primary colors and black with zero. The table retaining unit temporarily retains the temporary table. The data conversion unit converts the inputted image data into the print data using the temporarily-retained temporary table. The data output unit outputs the converted print data.

An image processing apparatus according to a second aspect of the present invention includes the table storage unit, the table retaining unit, the data input unit, the data conversion unit, the data output unit, an instruction input unit and the table processing unit. The table storage unit stores a plurality of look-up tables including a color table and a black and white table. The table retaining unit temporarily retains a look-up table for data conversion. Image data is inputted to the data input unit. The data conversion unit converts the inputted image data into the print data using the temporarily-retained look-up table. The data output unit outputs the converted print data. Print instructions for a color image, a black and white image, and a monochrome image are selectively inputted to the instruction unit. The table processing unit obtains the color table from the table storage unit to store the color table in the table retaining unit when the print instruction for the color image is inputted. The table processing unit obtains the black and white table from the table storage unit to store the black and white table in the table retaining unit when the print instruction for the black and white image is inputted. The table processing unit obtains the color table and the black and white table from the table storage unit to generate the temporary table and storing the generated temporary table in the table retaining unit when the print instruction for the monochrome image is inputted.

Consequently, in the image processing apparatus according to the first and second aspects of the present invention, a temporary table for converting full-color image data into monochrome image print data except for black is accurately generated in real time from the already-existing and necessary color and black and white tables.

As used herein, a monochrome color shall mean a color except for black. Specifically, a monochrome color includes cyan, magenta, yellow, cyan+magenta, cyan+yellow, magenta+yellow, and cyan+magenta+yellow.

An image processing apparatus according to a third aspect of the present invention includes a table storage unit, a data input unit, a table processing unit, a table retaining unit, a data conversion unit, and a data output unit. The table storage unit stores a color table for converting full-color image data including one lightness value and a plurality of color values into full-color print data including density values of three primary colors and black, and a black and white table for converting the full-color image data into black and white print data including a density value of black. The image data is inputted to the data input unit. The table processing unit generates a temporary table by replacing density values of three primary colors and black with a density value of a specific color in each the lightness value in one of a color portion where at least one of the plurality of color values of the color table is not zero and a black and white portion where all the color values of the color table are zero. The table retaining unit temporarily retains the temporary table. The data conversion unit converts the inputted image data into the print data using the temporarily-retained temporary table. The data output unit outputs the converted print data.

An image processing apparatus according to a fourth aspect of the present invention includes the table storage unit, the table regaining unit, the data input unit, data conversion unit, data output unit, an instruction unit, and table processing unit. The table storage unit stores a plurality of look-up tables including a color table and a black and white table. The table retaining unit temporarily retains a look-up table for data conversion. Image data is inputted to the data input unit. The data conversion unit converts the inputted image data into the print data using the temporarily-retained look-up table. The data output unit outputs the converted print data. Print instructions for a color image, a black and white image, and a special image are selectively inputted to the instruction input unit. The table processing unit obtains the color table from the table storage unit to store the color table in the table retaining unit when the print instruction for the color image is inputted. The table processing unit obtains the black and white table from the table storage unit to store the black and white table in the table retaining unit when the print instruction for the black and white image is inputted. The table processing unit obtains the color and black and white tables from the table storage unit to generate the temporary table and stores the generated temporary table in the table retaining unit when the print instruction for the special image is inputted.

Consequently, in the image processing apparatus according to the present invention, a temporary table for converting one of a color portion and a black and white portion of full-color image data into specific-color print data is accurately generated in real time from the already-existing and essential color and black and white tables.

Various components of the present invention may be formed in various ways so as to realize functions thereof. For example, the various components can be realized by dedicated hardware which exerts a predetermined function, an image processing apparatus to which a predetermined function is imparted by a computer program, a predetermined function which is realized in the image processing apparatus by a computer program, and any combination thereof and the like.

The various components of the present invention may not always be independently formed. For example, the plurality of components may be formed as one member, one component may be formed by a plurality of members, some component may constitute a part of another component, and a part of some component may overlap a part of another component.

In the present invention, causing the image processing apparatus to perform various operations corresponding to the computer program image shall also mean that the image processing apparatus controls the operations of various devices. For example, storing various pieces of data in the image processing apparatus may include that a CPU (Central Processing Unit) stores various pieces of data in an information storage medium such as a RAM (Random Access Memory) fixed to the image processing apparatus, and that the CPU stores various pieces of data in the information storage medium such as an FD (Flexible Disc-cartridge) exchangeably loaded on the image processing apparatus using an FDD (FD Drive).

As used herein, the “data is stored” shall mean that the apparatus of the present invention is in the “data is stored” state when used. Therefore, the data is not stored when the apparatus of the present invention is shipped, and the apparatus of the present invention is permitted to be setup in the state in which the data is stored before use.

Thus, in the image processing apparatus of the present invention, a temporary table for converting full-color image data into monochrome image print data except for black is accurately generated in real time from the already-existing and necessary color and black and white tables. Therefore, the monochrome image print data is generated from the full-color image data without increasing the required memory capacity for storing the look-up table.

Furthermore, in the image processing apparatus of the present invention, the temporary table for converting one of a color portion and a black and white portion of a full-color image data into specific-color print data is accurately generated in real time from the already-existing and necessary color and black and white tables. Therefore, special image print data is generated from the full-color image data without increasing the memory capacity required for storing the look-up table.

Other features, elements, processes, steps, characteristics and advantages of the present invention will be apparent from the following detailed description of embodiments of the present invention with reference to the attached drawings.

### BRIEF DESCRIPTION OF THE DRAWINGS

FIG. 1 is a block diagram of an image processing apparatus according to a first embodiment of the present invention;

FIG. 2A is a full-color table and FIG. 2B is a black and white (monochrome) table according to the first embodiment of the invention;

FIGS. 3A and 3B are three-dimensional look-up tables according to the first embodiment of the invention;

FIG. 4 is a flowchart of a data processing method performed by the image processing apparatus according to the first embodiment of the invention;

FIG. 5 is a mono-color table according to the first embodiment of the invention;

FIG. 6 is mono-color table according to a modification of the first embodiment of the invention;

FIG. 7 is a block diagram of an image processing apparatus according to a second embodiment of the present invention;

FIG. 8A is a full-color table and FIG. 8B is a black and white table according to the second embodiment of the invention;

FIGS. 9A and 9B are three-dimensional look-up tables according to the second embodiment of the invention;

FIG. 10 is a flowchart of a data processing method performed by the image processing apparatus according to the second embodiment of the invention;

FIGS. 11A and 11B are two-color tables according to the second embodiment of the invention; and

FIG. 12 is a three-dimensional two-color table according to the second embodiment of the invention.

### DETAILED DESCRIPTION OF PREFERRED EMBODIMENTS

### First Embodiment

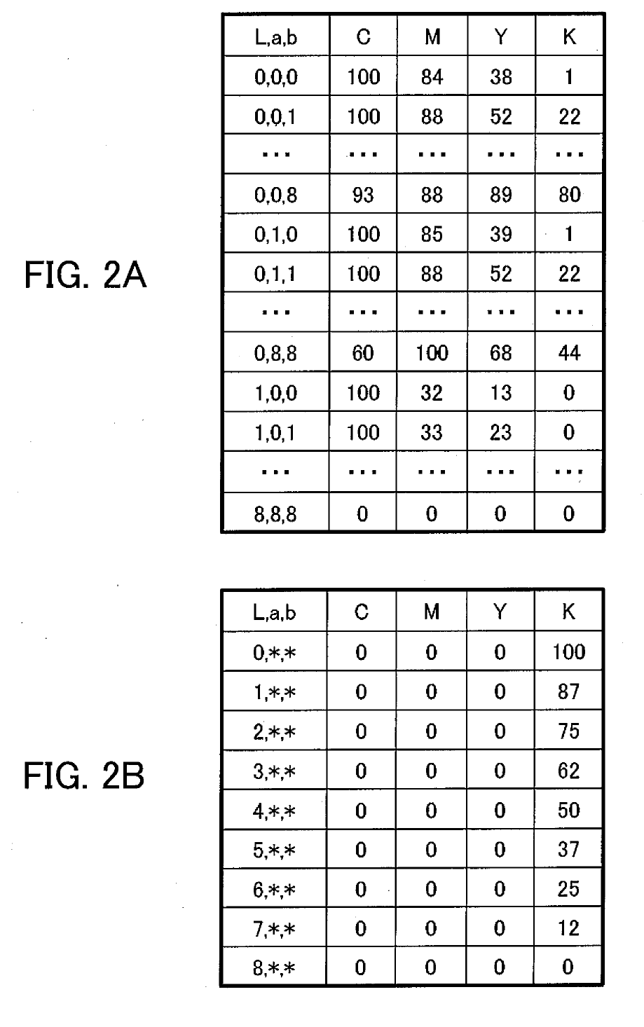

A first embodiment of the present invention will be described below with reference to the drawings. An image processing apparatus 100 of the first embodiment has a plurality of look-up tables of a full-color table and a black and white (monochrome) table. As illustrated in FIG. 2A, the full-color table converts full-color image data including one lightness value (L) and a plurality of color values (a, b) into full-color print data including density values of three primary colors (CMY) and black (K). As illustrated in FIG. 2B, the black and white table converts full-color image data into black and white print data including a density value of black (K). One of the plurality of look-up tables is selected to convert image data into print data.

The image processing apparatus 100 includes a table processing unit 110. The table processing unit 110 replaces the density value of at least a part of the three primary colors (CMY) of the full-color table with the density value of the black and white table. The table processing unit 110 replaces all density values of other parts of the three primary colors (CMY) and black (K) with zero. Then the processing unit 110 generates a mono-color table which is a temporary table of one of the look-up tables.

The image processing apparatus 100 of the first embodiment corresponds to a so-called personal computer, and is formed by general-purpose devices such as a CPU, a ROM (Read Only Memory), a RAM, and an I/F (interface) unit so as to be able to read a computer program to perform corresponding data processing.

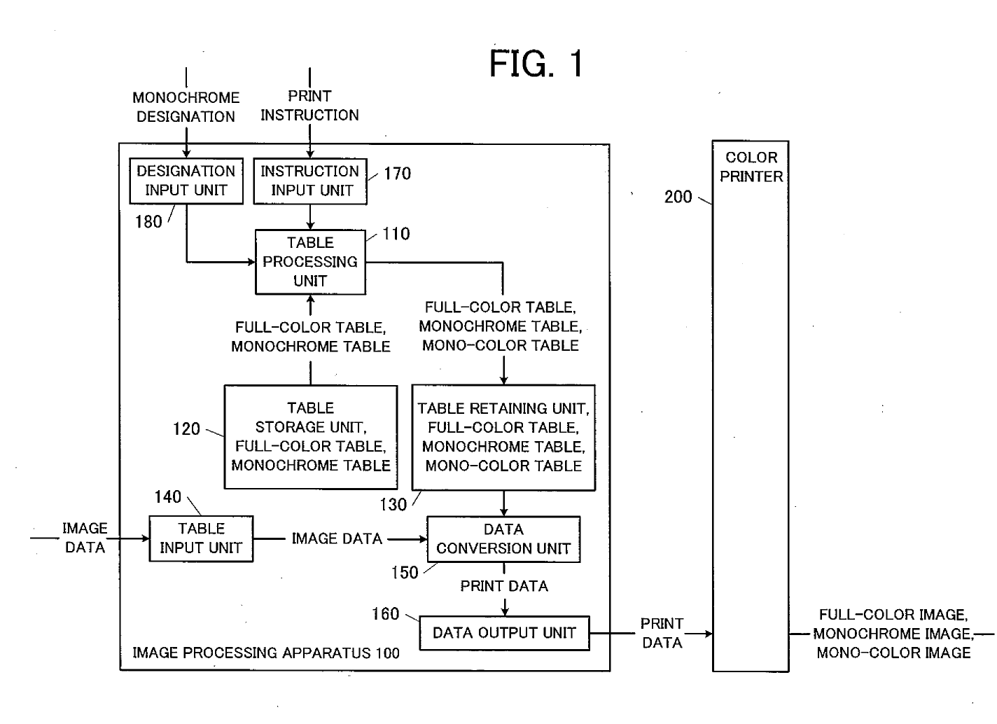

As illustrated in FIG. 1, the image processing apparatus 100 is connected to a color printer 200. The color printer 200 generates a print image with corresponding color inks of CMYK when receiving print data of CMYK from the image processing apparatus 100.

Application software of a printer controller corresponding to the color printer 200 is installed in the image processing apparatus 100. In the image processing apparatus 100, the table processing unit 110 and units 120-180 are logically formed as various functions of the application software.

Therefore, the image processing apparatus 100 further includes a table storage unit 120, a table retaining unit 130, a data input unit 140, a data conversion unit 150, a data output unit 160, and an instruction input unit 170. A plurality of three-dimensional look-up tables is stored in the table storage unit 120. The table retaining unit 130 temporarily retains a look-up table. Image data is inputted to the data input unit 140. The data conversion unit 150 converts the inputted image data into print data using the temporarily-retained look-up table (and interpolating computation and the like). The data output unit 160 outputs the converted print data. Print instructions for color, black and white, and/or monochrome images are selectively inputted to the instruction input unit 170.

When a print instruction for a color image is inputted, the table processing unit 110 obtains the full-color table as illustrated in FIG. 2A from the table storage unit 120 and stores the full-color table in the table retaining unit 130. When a print instruction for a black and white image is inputted, the table processing unit 110 obtains the black and white table as illustrated in FIG. 2B from the table storage unit 120 and stores the black and white table in the table retaining unit 130.

When a print instruction for a monochrome image is inputted, the table processing unit 110 obtains the full-color and black and white tables from the table storage unit 120 and stores the full-color and black and white tables in the table retaining unit 130. At this point, as described above, the table processing unit 110 generates a mono-color table by replacing the density value of at least a part of the three primary colors (CMY) of the full-color table with the density value of the black and white table and by replacing all density values of other parts of the three primary colors (CMY) and black (K) with zero.

The image processing apparatus 100 also includes a designation input unit 180. Designation data of at least a part of the three primary colors, replaced with the density value of the black and white table, is inputted to the designation input unit 180. Therefore, the table processing unit 110 replaces the density value in at least the part of the three primary colors with the density value of the black and white table according to the inputted designation data.

Each unit of the image processing apparatus 100 is realized by utilizing hardware such as an I/F unit if needed. The entity is realized by the CPU (hardware) that acts according to a computer program (software) stored in an information storage medium such as the RAM.

The computer program causes the CPU to perform processing operations including storing the full-color and black and white tables as the plurality of look-up tables; selectively accepting print instructions for color, black and white, and monochrome images; accepting designation data of at least a part of the three primary colors, replaced with the density value of the black and white table; accepting an input of image data according to a print instruction or the like; converting image data into print data using the full-color table when a print instruction for a color image is inputted; converting image data into print data using the black and white table when a print instruction for a black and white image is inputted; replacing the density value of at least a part of the three primary colors of the full-color table with the density value of the black and white table according to the designation data, and replacing all density values of other parts of the three primary colors and black with zero when a print instruction for a monochrome image is inputted, thereby generating a mono-color table which is used to convert image data into print data; and outputting the converted print data to the color printer 200.

A data processing method performed by the image processing apparatus 100 is described below. In the image processing apparatus 100, the full-color and black and white tables are registered as three-dimensional look-up tables. As illustrated in FIG. 2A, the full-color table converts image data of (L, a, b) into print data of a CMYK color image. As illustrated in FIG. 2B, the black and white table converts image data of (L, a, b) into print data of a black and white image. In the black and white table, CMY are set to zero to thereby enable only K.

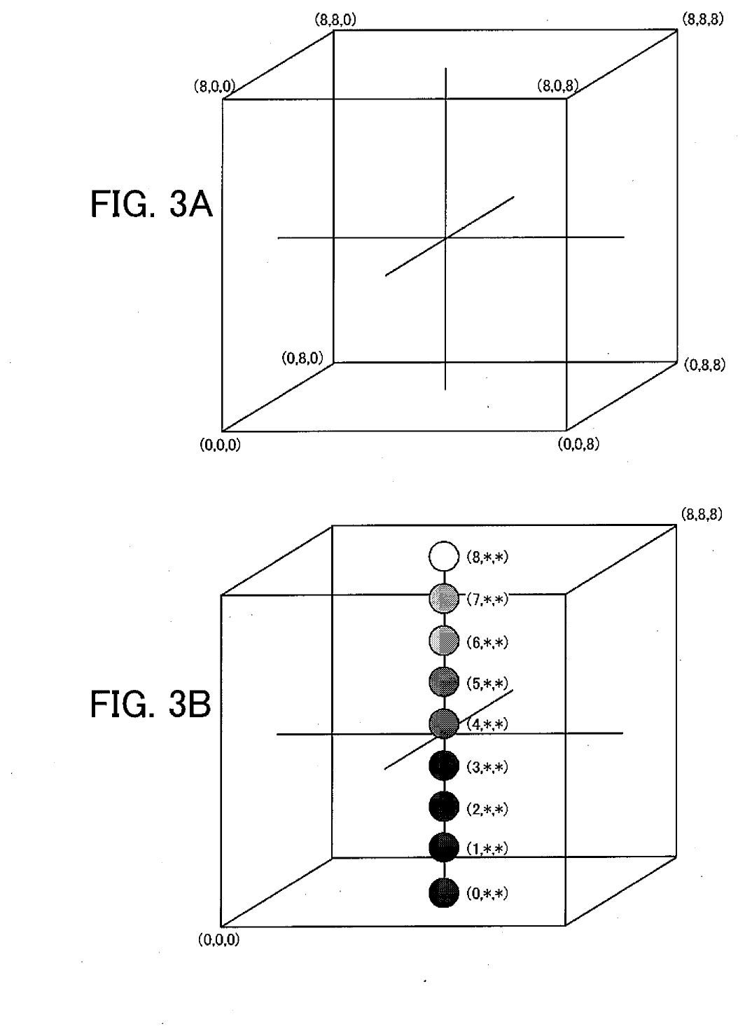

When the (L, a, b) look-up table is schematically expressed in a three-dimensional manner, all colors of the print data are arranged in a space of (0-8)×(0-8)×(0-8) as illustrated in FIG. 3.

In the three-dimensional space, a vertical direction constitutes lightness, and chroma saturation becomes zero in the centers of a horizontal direction and a depth direction. Therefore, as illustrated in FIG. 3B, (L, a, b)=(*, 4, 4) expresses an achromatic color (black and white) having only the lightness without the chroma saturation (the sign * is an arbitrary numerical value ranging from zero to eight).

When an operator causes the image processing apparatus 100 to convert image data into print data and to output the print data to the color printer 200, the operator inputs a print instruction for a color, black and white, or monochrome image to the image processing apparatus 100 while selecting the image data.

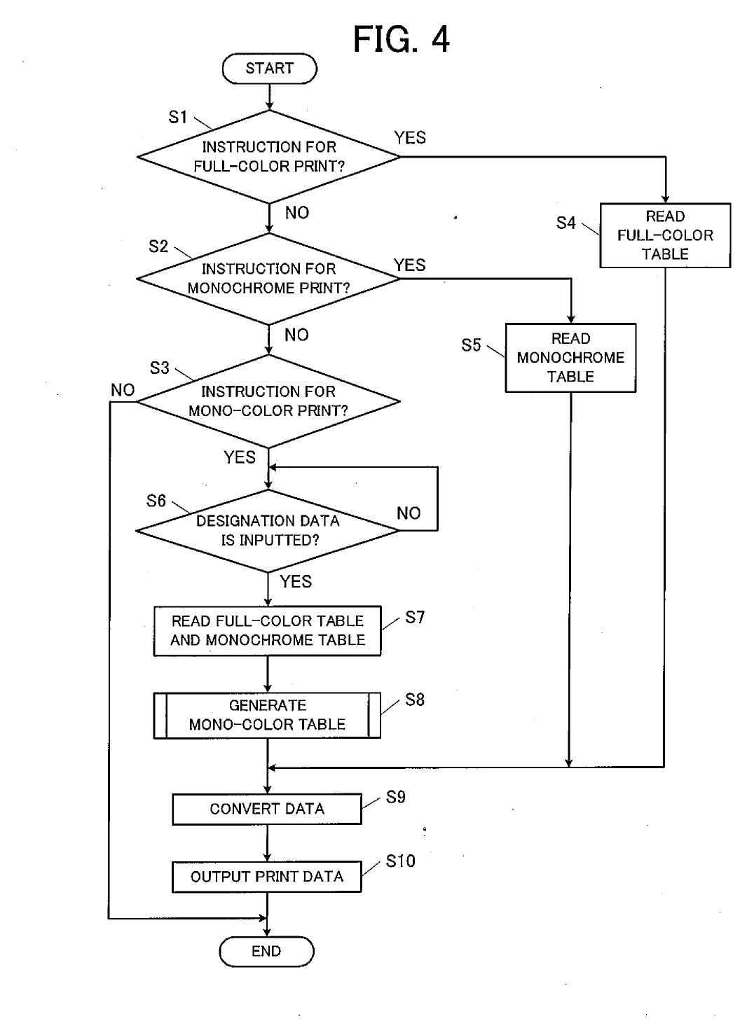

As illustrated in FIG. 4, because the image processing apparatus 100 always stands by for an input operation of a color, black and white, or a monochrome image (Steps S1-S3), the image processing apparatus 100 starts a corresponding processing operation when detecting the input operation (Steps S4-S6).

That is, when a print instruction for a color image is inputted (Step S1), the image processing apparatus 100 reads the full-color table from the ROM to temporarily retain the full-color table in a work area of the RAM (Step S4).

The image processing apparatus 100 converts the (L, a, b) image data into CMYK full-color print data using the temporarily-retained full-color table (Step S9), and the image processing apparatus 100 outputs the CMYK full-color print data to the color printer 200 (Step S10). This enables the color printer 200 to print out the CMYK color image using the inputted print data.

When a print instruction for a black and white image is inputted to the image processing apparatus 100 (Step S2), the image processing apparatus 100 reads the black and white table (Step S5). The image processing apparatus 100 converts the (L, a, b) image data into black and white print data using the black and white table (Step S9), and the image processing apparatus 100 outputs the black and white print data to the color printer 200 (Step S10). This enables the color printer 200 to print out the black and white image using the inputted print data.

When a print instruction for a monochrome image is inputted to the image processing apparatus 100 (Step S3), the image processing apparatus 100 stands by for an input operation of monochrome designation data (Step S6). At this point, a guidance message such as “Select the printed monochrome color from the following items; cyan, magenta, yellow, cyan+magenta, cyan+yellow, magenta+yellow, and cyan+magenta+yellow” is displayed on a display of the image processing apparatus 100.

When the operator designates the desired monochrome color, the image processing apparatus 100 reads the full-color table and the black and white table to generate a mono-color table (Steps S7 and S8). In this case, the read full-color table is stored in the work area, the image processing apparatus 100 replaces the density value of a part of the three primary colors (CMY) corresponding to the designated monochrome color with the density value of the black and white table, and the image processing apparatus 100 replaces all density values of other parts of the three primary colors (CMY) and black (K) with zero.

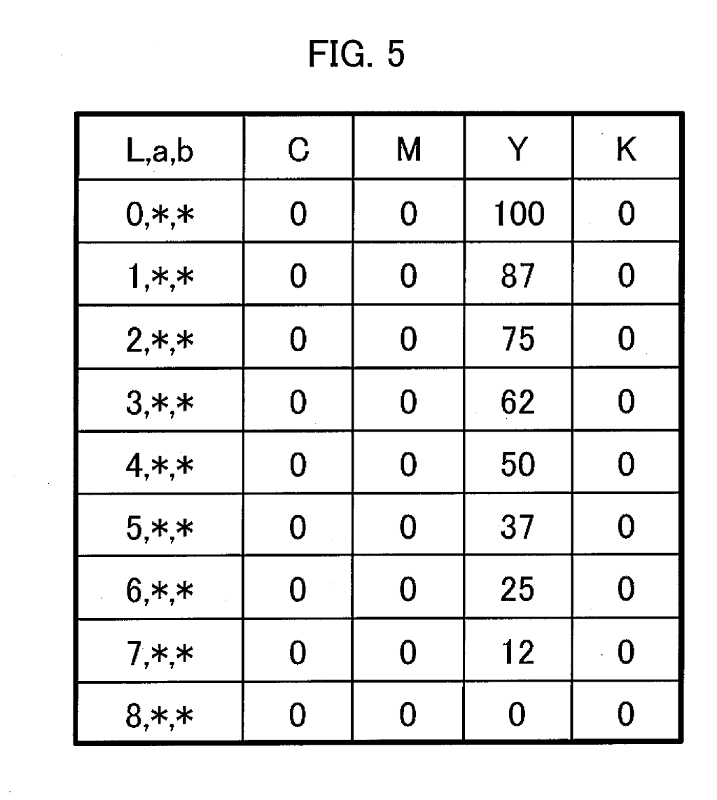

For example, when yellow is selected as the monochrome color, as illustrated in FIG. 5, the density value of Y which is of a part of the three primary colors is replaced with the density value of the black and white table, and all density values of CMK which are of other parts of the three primary colors and black are replaced with zero.

Thus, when the mono-color table is generated, the (L, a, b) image data is converted into monochrome print data using the mono-color table (Step S9). The image processing apparatus 100 outputs the print data to the color printer 200 (Step S10), and the color printer 200 prints out a monochrome image using the inputted print data.

As described above, in the image processing apparatus 100, a mono-color table for converting full-color image data into monochrome image print data except for black is accurately generated in real time from the already-existing and essential full-color and black and white tables. Therefore, monochrome image print data is generated from full-color image data without increasing the memory capacity required for storing the look-up tables.

Furthermore, the image processing apparatus 100 accepts mono-color designation data replaced with the density value of the black and white table, and the density value in at least a part of the three primary colors is replaced with the density value of the black and white table according to the designation data. This enables image data to be printed out in a mono-color at the operator's request.

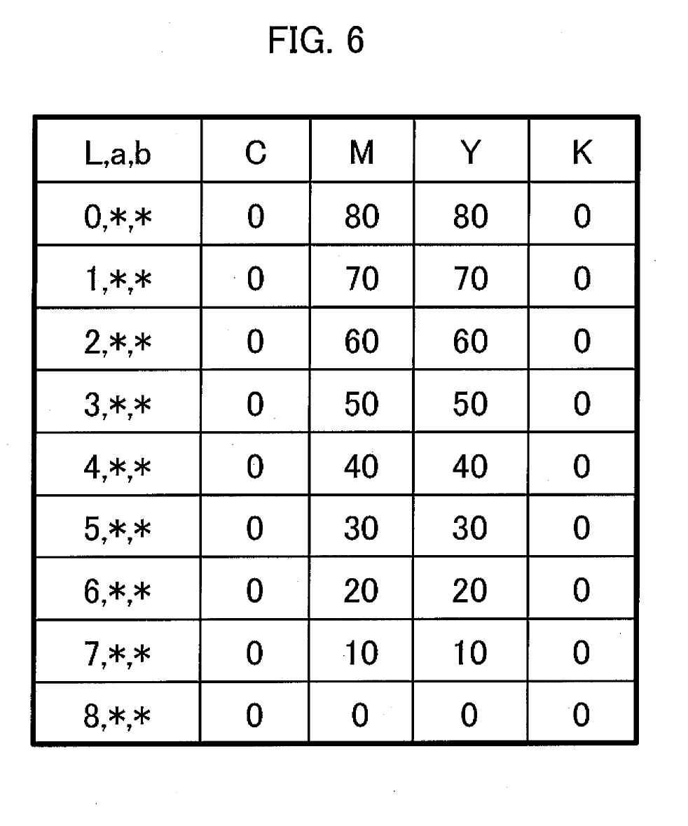

The present invention is not limited to the first embodiment, and various modifications may be made without departing from the scope of the present invention. In the first embodiment, one of the density values of the three primary colors in the full-color table is replaced with the density value of the black and white table. However, as illustrated in FIG. 6, more than one density value of the three primary colors in the full-color table may be replaced with the density value of the black and white table.

In the first embodiment, the density values of the full-color table are directly replaced with the density value of the black and white table. However, as illustrated in FIG. 6, the density values of the full-color table may be replaced after a factor, such as 0.8 for example, is multiplied by the density value of the black and white table.

Generally, print with black ink is not completely synchronized with print with color ink in a rate of lightness change by visual inspection. Therefore, when the density value of the full-color table is directly replaced with the density value of the black and white table, the number of density steps of visual inspection is sometimes decreased in monochrome print.

However, when the density values of the full-color table are replaced after a factor such as 0.8 or the like is multiplied by the density values of the black and white table, the number of density steps of visual inspection in monochrome print can be equalized to that in black and white print.

In the case where a designated color can be expressed by parts (for example, only C and M) of the three primary colors of the full-color table, the density values in the parts (for example, only C and M) of the three primary colors of the full-color table are converted into the density values of the black and white table. In the case where the designated color can be expressed by all three primary colors (CMY) of the full-color table, namely, in the case where all three primary colors of the full-color table are required to express the designated color, the density values in all three primary colors (CMY) of the full-color table are converted into the density values of the black and white table. In the case where the density values in all three primary colors of the full-color table are replaced with the density values of the black and white table, because CMY are mixed with the same ratio when the factor is identical for the three primary colors, the generated monochrome color becomes a pseudo achromatic color.

Therefore, in the case where the density values in all the three primary colors of the full-color table are replaced with the density values of the black and white table, at least one of the factors for the three primary colors is caused to differ from other factors, allowing the generation of the mono-color except for the achromatic color.

Furthermore, in the first embodiment, the image processing apparatus 100 always stands by for manipulation whether a color, black and white, or monochrome image is inputted, and the image processing apparatus 100 starts the corresponding processing operation when detecting the input manipulation. Alternatively, for example, a default setting may be provided such that a color image is printed by default, and black and white and monochrome prints are performed only when specifically designated by input manipulation.

In the first embodiment, the CPU is operated according to the computer program stored in the RAM or the like, which allows the units to be logically realized as various functions of the image processing apparatus 100.

Alternatively, the units may be formed as hardware, or partially formed as software and partially formed as hardware.

### Second Embodiment

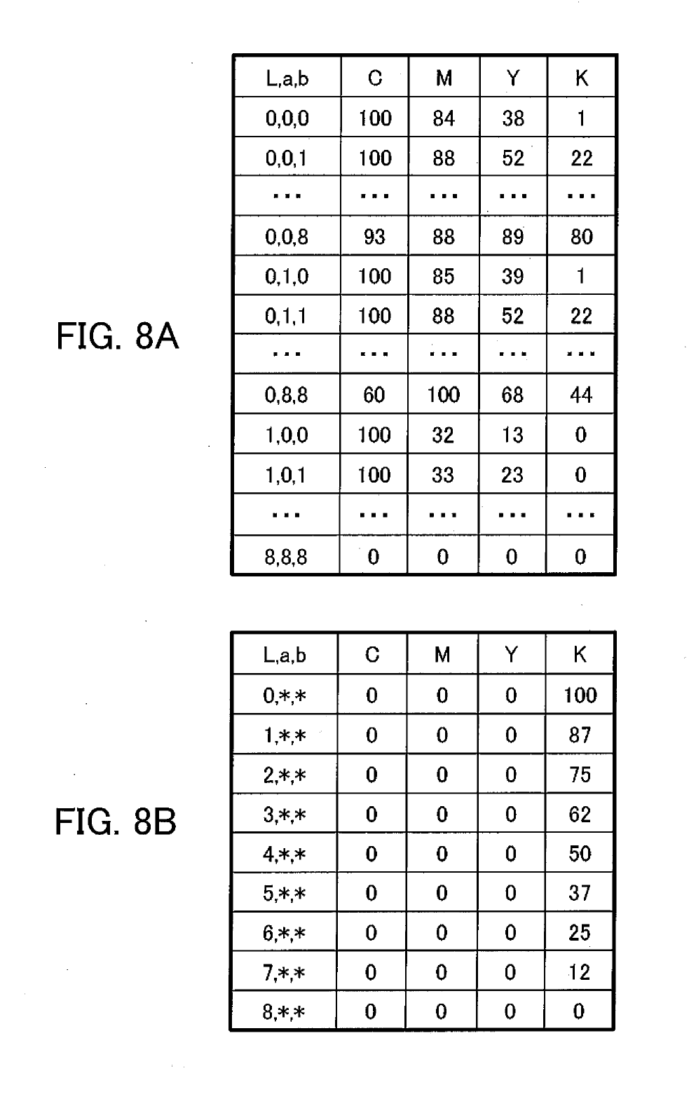

A second embodiment of the present invention will be described below with reference to the drawings. An image processing apparatus 300 of the second embodiment has a plurality of look-up tables of a full-color table and a black and white (monochrome) table. As illustrated in FIG. 8A, the full-color table converts full-color image data including one lightness value (L) and a plurality of color values (a, b) into full-color print data including density values of three primary colors (CMY) and black (K). As illustrated in FIG. 8B, the black and white table converts full-color image data into black and white print data including a density value of black (K). One of the plurality of look-up tables is selected to convert image data into print data.

Furthermore, the image processing apparatus 300 includes a table processing unit 310. The table processing unit 310 generates a two-color table which is a temporary table of one of the look-up tables by replacing density values of the three primary colors (CMY) and black (K) with a density value of a specific color in each lightness value (L) in one of the color portions where at least one of the plurality of color values (a, b) of the full-color table is not zero and the black and white portion where all the color values (a, b) are zero.

The image processing apparatus 300 of the second embodiment corresponds to the so-called personal computer, and is formed by general-purpose devices such as a CPU, a ROM (Read Only Memory), a RAM, and an I/F (interface) unit so as to be able to read the computer program to perform the corresponding data processing.

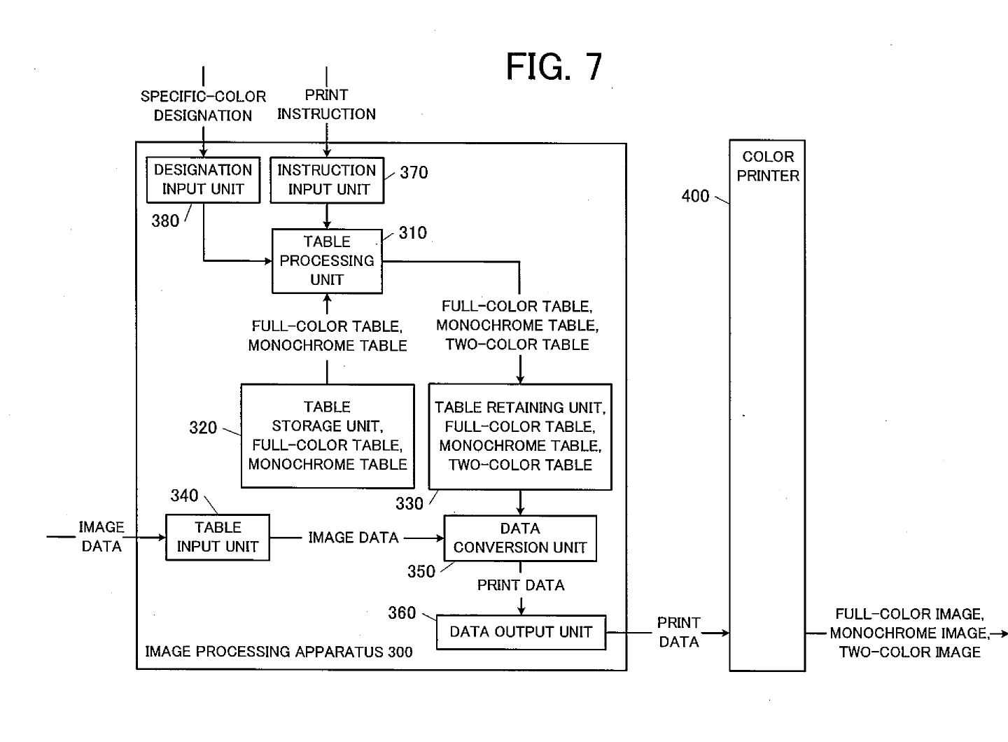

As illustrated in FIG. 7, the image processing apparatus 300 is connected to a color printer 400. The color printer 400 generates a print image with corresponding color inks of CMYK when receiving print data of CMYK from the image processing apparatus 300.

Application software of a printer controller corresponding to the color, printer 400 is installed in the image processing apparatus 300. In the image processing apparatus 300, the table processing unit 310 and units 320 to 380 are logically formed as various functions of the application software.

Therefore, the image processing apparatus 300 further includes a table storage unit 320, a table retaining unit 330, a data input unit 340, a data conversion unit 350, a data output unit 36, and an instruction input unit 370. The plurality of three-dimensional look-up tables is stored in the table storage unit 320. The table retaining unit 330 temporarily retains a look-up table. Image data is inputted to the data input unit 340. The data conversion unit 350 converts the inputted image data into print data using the temporarily-retained look-up table (and interpolating computation and the like). The data output unit 360 outputs the converted print data. Print instructions for a color image, a black and white image, and/or a special two-color image are selectively inputted to the instruction input unit 370.

When a print instruction for a color image is inputted, the table processing unit 310 obtains the full-color table as illustrated in FIG. 8A from the table storage unit 320 and stores the full-color table in the table retaining unit 330. When a print instruction for a black and white image is inputted, the table processing unit 310 obtains the black and white table as illustrated in FIG. 8B from the table storage unit 320 and stores the black and white table in the table retaining unit 330. When a print instruction for a two-color image is inputted, the table processing unit 310 obtains the full-color and black and white tables from the table storage unit 320 and stores the two-color table in the table retaining unit 330.

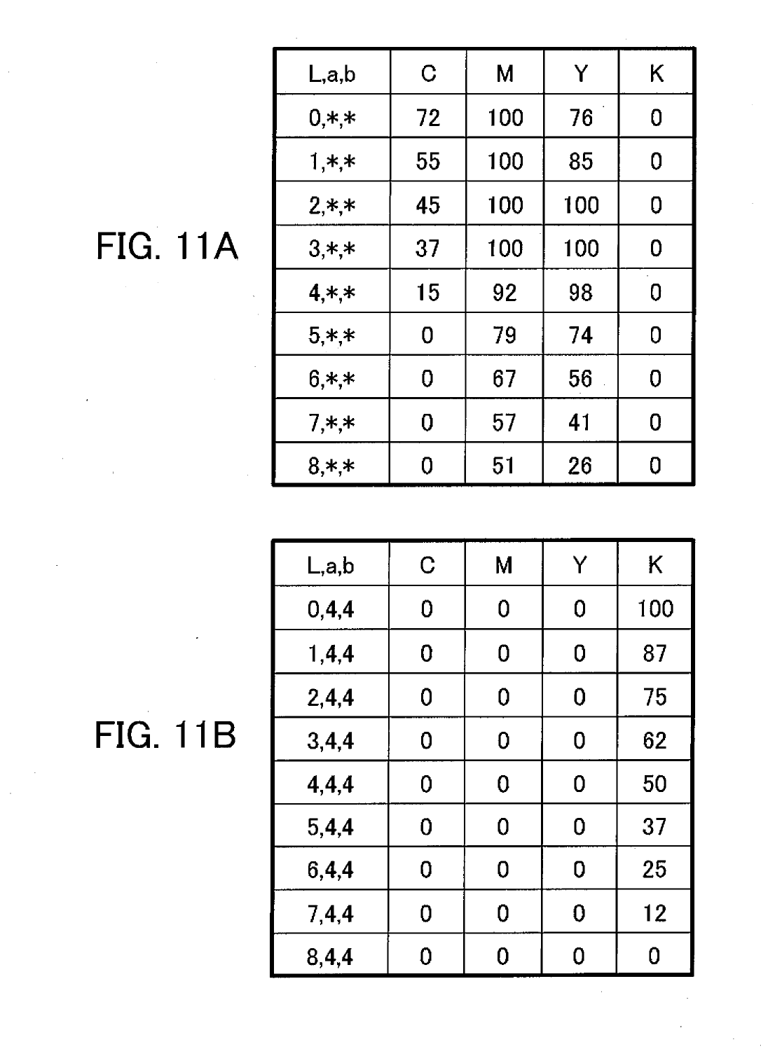

At this point, although described in detail later, as illustrated in FIG. 11A, while the table processing unit 310 replaces the density values of the three primary colors (CMY) with a density value of a first specific color in each lightness value (L) in the color portion where at least one of the plurality of color values (a, b) of the full-color table is not zero, the table processing unit 310 replaces the density value of black (K) with zero.

As illustrated in FIG. 11B, the table processing unit 310 replaces the density values of three primary colors (CMY) and black (K) with the density value of the black and white table which is of a density value of a second specific color in each lightness value (L) in the black and white portion where all the color values (alb) of the full-color table are zero.

The image processing apparatus 300 also includes a designation input unit 380. Designation data of a first specific color is inputted to the designation input unit 380. Therefore, the table processing unit 310 replaces the density values of the three primary colors with the density value of the specific color in each lightness value according to the inputted designation data.

Each unit of the image processing apparatus 300 is realized by utilizing hardware such as an I/F unit if needed. The entity is realized by the CPU (hardware) that functions according to the computer program (software) stored in the information storage medium such as the RAM.

The computer program causes the CPU to perform processing operations including storing the full-color and black and white tables as the plurality of look-up tables; selectively accepting print instructions for color, black and white, and two-color images; accepting designation data of a first specific color; accepting image data input according to a print instruction or the like; converting the image data into print data using the full-color table when a print instruction for a color image is inputted; converting image data into print data using the black and white table when a print instruction for a black and white image is inputted; replacing the density values of the three primary colors of the full-color table with the density value of a first specific color in each lightness value according to the designation data, replacing the density value of black with zero, and replacing the density value in the black and white portion of the full-color table with the density value of the black and white table in each lightness value when a print instruction for a two-color image is inputted, thereby generating a two-color table used to convert the image data into print data; and outputting the converted print data to the color printer 400.

A data processing method performed by the image processing apparatus 300 is described below. The full-color and black and white tables are registered in the image processing apparatus 300 as three-dimensional look-up tables. As illustrated in FIG. 8A, the full-color table converts image data of (L, a, b) into print data of a CMYK color image. As illustrated in FIG. 8B, the black and white table converts image data of (L, a, b) into print data of a black and white image. In the black and white table, CMY are set to zero to thereby enable only K.

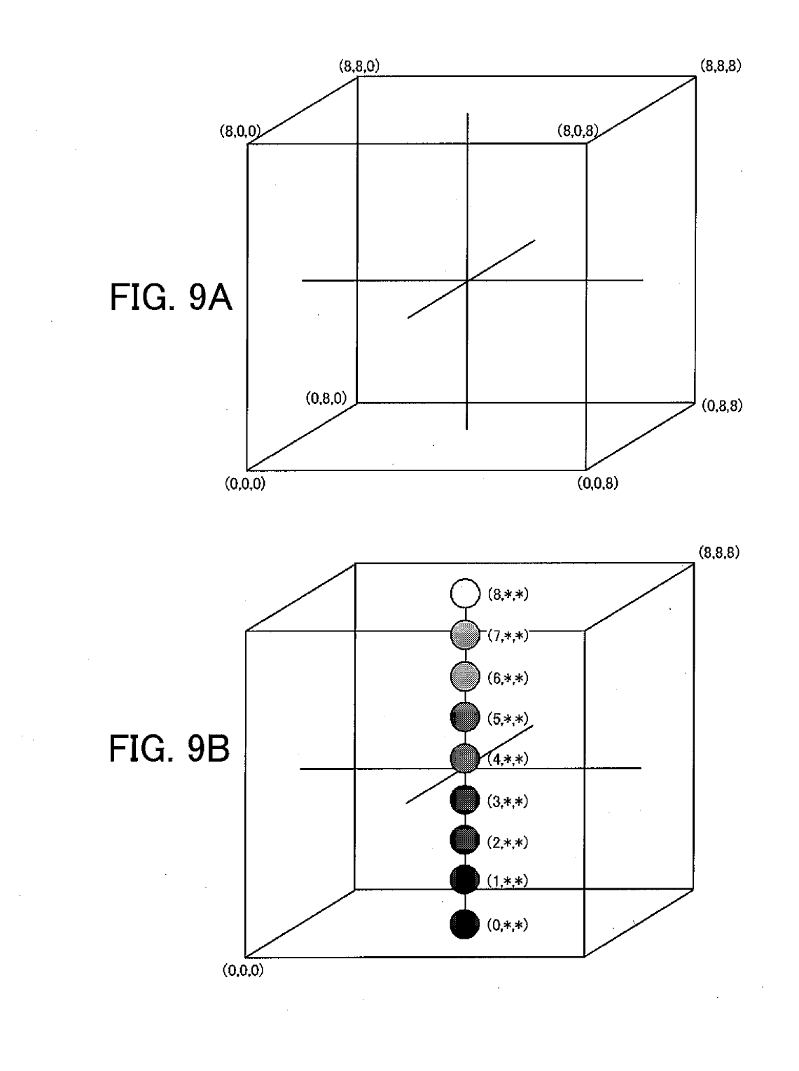

When the (L, a, b) look-up table is schematically expressed in the three-dimensional manner, all colors of the print data are arranged in the space of (0-8)×(0-8)×(0-8) as illustrated in FIG. 9.

In the three-dimensional space, a vertical direction constitutes lightness, and chroma saturation becomes zero in the centers of a horizontal direction and a depth direction. Therefore, as illustrated in FIG. 9B, (L, a, b)=(*, 4, 4) expresses an achromatic color (black and white) having only the lightness without the chroma saturation (the sign * is an arbitrary numerical value ranging from zero to eight). That is, in the second embodiment, the color value becomes zero in the case of (a, b)=(4, 4) in the image data and full-color table.

When an operator causes the image processing apparatus 300 to convert image data into print data and to output the print data to the color printer 400, the operator inputs a print instruction for a color, black and white, or two-color image to the image processing apparatus 300 while selecting the image data.

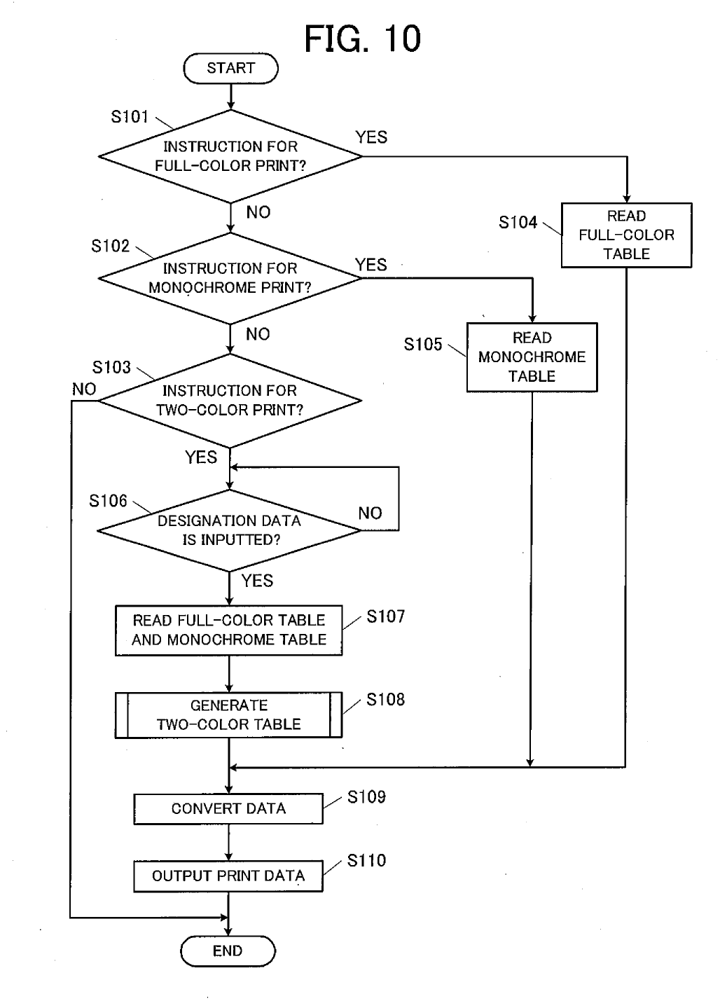

As illustrated in FIG. 10, because the image processing apparatus 300 always stands by for an input operations of a color, black and white, or two-color image (Steps S101-S103), the image processing apparatus 300 starts the corresponding processing operation when detecting the input operation (Steps S104 to S106).

That is, when a print instruction for a color image is inputted (Step S101), the image processing apparatus 300 reads the full-color table from the ROM to temporarily retain the full-color table in the work area of the RAM (Step S104).

The image processing apparatus 300 converts the (L, a, b) image data into CMYK full-color print data using the temporarily-retained full-color table (Step S109), and the image processing apparatus 300 outputs the CMYK full-color print data to the color printer 400 (Step S110). This enables the color printer 400 to print out a CMYK color image using the inputted print data.

When a print instruction for a black and white image is inputted to the image processing apparatus 300 (Step S102), the image processing apparatus 300 reads the black and white table (Step S105). The image processing apparatus 300 converts the (L, a, b) image data into black and white print data using the black and white table (Step S109), and the image processing apparatus 300 outputs the black and white print data to the color printer 400 (Step S110). This enables the color printer 400 to print out a black and white image using the inputted print data.

When a print instruction for a two-color image is inputted to the image processing apparatus 300 (Step S103), the image processing apparatus 300 stands by for the input operation of specific-color designation data (Step S106).

At this point, a rectangular image (not illustrated) in which the colors are arrayed in two-dimensional manner is displayed on a display of the image processing apparatus 300 along with a guidance message such as “Point the specific color used in the two-color print”.

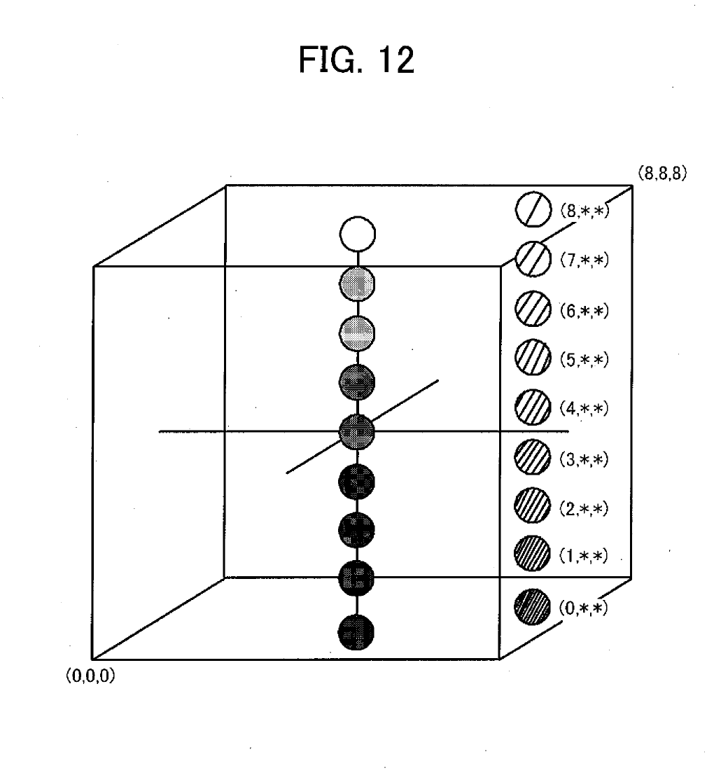

In the three-dimensional look-up table illustrated in FIG. 9, the rectangular image corresponds to a horizontal section where the lightness L is located at latitude of 4. For example, when a specific color of (L, a, b)=(*, 7, 7) is designated, the density values (L, a, b)=(0, 7, 7) to (8, 7, 7) in which each of the two color values (a, b) is constant become the density value of the specific color as illustrated in FIG. 12.

When an operator designates a desired specific color, the image processing apparatus 300 reads the full-color and black and white tables to generate a two-color table (Steps S107 and S108).

In this case, the image processing apparatus 300 stores the read full-color table in the work area. Then, as illustrated in FIG. 11A, the image processing apparatus 300 replaces the density values of the three primary colors (CMY) in the color portion of the full-color table with the density value of the designated specific color, and the image processing apparatus 300 replaces the density value of black (K) with zero. As used herein the color portion of the full-color table shall mean a portion where at least one of the color values “a” and “b” in Lab is not zero (coordinate of 4 in the illustrated example). That is, the portion where at least one of the color values “a” and “b” is not zero corresponds to the color portion. The black and white portion of the full-color table shall mean a portion where both the color values “a” and “b” in Lab become zero (coordinate of 4 in the illustrated example). That is, the portion where both the color values “a” and “b” become zero corresponds to the black and white portion.

Then, as illustrated in FIG. 11B, the image processing apparatus 300 replaces the density values of the three primary colors (CMY) and black (K) in the black and white portion of the full-color table with the density value of the black and white table in each lightness value (L). That is, the image processing apparatus 300 generates the density values of the three primary colors and black in the black and white portion of the full-color table, which constitute the two-color table, using the black and white table (FIG. 8B). At this point, the image processing apparatus 300 replaces the density values of the three primary colors (CMY) in the black and white portion with zero.

FIG. 11A illustrates the color portion of the generated two-color table, and FIG. 11B illustrates the black and white portion. When the two-color table is generated, the image processing apparatus 300 converts (L, a, b) image data into print data including the specific color and black (K) using the two-color table (Step S109). Because the image processing apparatus 300 outputs the print data to the color printer 400 (Step S110), the color printer 400 prints out the two-color image using the inputted print data.

In the two-color image printed out in the above-described manner, the gray-scale print in specific color is performed to the color portion which has the chroma saturation in the full-color image data, and the gray-scale print in black is performed to the black and white portion which does not have the chroma saturation.

In the image processing apparatus 300 according to the second embodiment of the present invention, as described above, the two-color table for converting full-color image data into print data of a two-color image is accurately generated in real time from the already-existing and essential full-color and black and white tables. Therefore, the two-color image print data is generated from the full-color image data without increasing the memory capacity required for storing the look-up table.

Furthermore, the image processing apparatus 300 accepts input of specific-color designation data, and the image processing apparatus 300 replaces the color portion (output value) of the full-color table such that the color portion becomes the specific color. Therefore, the gray-scale print in a desired specific color can be performed to the color portion of the full-color image data only by designating one specific color.

Additionally, the black and white portion of the full-color table is automatically replaced with the black and white table. That is, the image processing apparatus 300 replaces the black and white portion of the full-color table which is of the two-color table such that the black and white portion becomes the values of the black and white table illustrated in FIG. 8B. Therefore, the gray-scale print can automatically be performed to the black and white portion of the full-color image data. Accordingly, two-color print of the specific color and black is easily realized by designating one specific color.

The present invention is not limited to these embodiments, and various modifications may be made without departing from the scope of the present invention. In the second embodiment, input of specific-color designation data is accepted and the color portion of the full-color table is replaced with the specific color. However, the specific color may be set as a default value. In this case, a user may previously select a specific color as the default value from three primary colors.

In the second embodiment, the density value in the color portion of the full-color table is replaced with the density value of the specific color, the density value in the black and white portion is replaced with the density value of the black and white table which is of the second specific color.

Alternatively, the density value in the black and white portion may be replaced with the density value of the specific color while the density value in the color portion is replaced with the density value of the black and white table. In this case, in full-color image data, gray-scale print in black is performed to the color portion having the chroma saturation, and the gray-scale print in specific color is performed to the black and white portion which does not have the chroma saturation.

Alternatively, the density value in the black and white portion may be replaced with the density value of a second specific color while the density value in the color portion is replaced with the density value of the first specific color. In this case, the gray-scale print in specific color is performed to the color portion of the full-color image data, and the gray-scale print in the second specific color is performed to the black and white portion.

Alternatively, the density value in the black and white portion may be replaced with zero while the density value in the color portion is replaced with the density value of the specific color. In this case, gray-scale print in specific color is performed to the color portion of the full-color image data, and the print is not performed to the black and white portion.

On the contrary, the density value in the black and white portion may be replaced with the density value of the specific color while the density value in the color portion is replaced with zero. In this case, the print is not performed to the color portion of the full-color image data, and the gray-scale print in specific color is performed to the black and white portion.

In the second embodiment, the density value in the portion where the two color values are constant is utilized as the density value in the specific color as illustrated in FIG. 12. However, when the density value is actually used, sometimes the density value is not suitable to the monochrome gray-scale print.

This is attributed to the fact that the three-dimensional look-up table is entirely adjusted in the optimum state by visual inspection. In the case where the density value becomes problem, the density value of the full-color table around the portion where each of the plurality of color values is constant can previously be defined as the density value of the specific color. That is, not the density value in the portion where each of the plurality of color values is constant, but the density value extracted from the predetermined range centered around the portion where each of the plurality of color values is constant can be used.

In this case, the density value is selected in each specific color and registered as the data. However, because the registered data includes only the coordinate of the density value, the data capacity is not largely increased.

In the second embodiment, the image processing apparatus 300 always stands by for input manipulation of a color image, a black and white image, or a two-color image, and the image processing apparatus 300 starts the corresponding processing operation when detecting the input manipulation. Alternatively, for example, a default setting may be provided such that a color image is printed by default, and a black and white or two-color print is performed only when specifically designated by input manipulation.

In the second embodiment, the CPU is operated according to the computer program stored in the RAM, which allows the units to be logically realized as various functions of the image processing apparatus 300.

Alternatively, the units may be formed as hardware, or partially formed as software and partially formed as hardware.

While the present invention has been described with respect to embodiments thereof, it will be apparent to those skilled in the art that the invention may be modified in numerous ways and may assume many embodiments other that those specifically set out and described above. Accordingly, the appended claims are intended to cover all modifications that fall within the true spirit and scope of the present invention.

What is claimed is:

1. An image processing apparatus comprising:
a table storage unit in which a color table and a black and white table are stored, the color table for converting full-color image data including one lightness value and a plurality of color values into full-color print data including density values of three primary colors and black, the black and white table for converting said full-color image data into black and white print data including a density value of black;
a data input unit to which said image data is inputted;
a table processing unit which generates a temporary table by replacing a density value in at least a part of said three primary colors of said color table with a density value of said black and white table while replacing all the density values in other parts of said three primary colors and black with zero;
a table retaining unit which temporarily retains said temporary table;
a data conversion unit which converts said inputted image data into said print data using said temporarily-retained temporary table; and
a data output unit which outputs said converted print data.

2. The image processing apparatus according to claim 1, wherein said table processing unit replaces a density value in at least a part of said three primary colors of said color table by multiplying a density value of said black and white table by a predetermined factor.

3. The image processing apparatus according to claim 2, wherein said table processing unit causes at least said one factor to differ for said three primary colors when replacing density values in all said three primary colors of said color table with a density value of said black and white table.

4. An image processing apparatus comprising:
a table storage unit in which a plurality of look-up tables including a color table and a black and white table are stored;
a table retaining unit which temporarily retains a look-up table for data conversion;
a data input unit to which image data is inputted;
a data conversion unit which converts said inputted image data into said print data using said temporarily-retained look-up table;
a data output unit which outputs said converted print data;
an instruction input unit to which print instructions for a color image, a black and white image, and a monochrome image are selectively inputted; and
a table processing unit which obtains said color table from said table storage unit to store said color table in said table retaining unit when said print instruction for said color image is inputted, the table processing unit obtaining said black and white table from said table storage unit to store said black and white table in said table retaining unit when said print instruction for said black and white image is inputted, the table processing unit obtaining said color table and said black and white table from said table storage unit to generate said temporary table and storing said generated temporary table in said table retaining unit when said print instruction for said monochrome image is inputted.

5. The image processing apparatus according to claim 4, further including a designation input unit to which designation data of at least a part of said three primary colors is inputted, the designation data of at least the part of said three primary colors being replaced with a density value of said black and white table,
wherein said table processing unit replaces a density value in at least a part of said three primary colors with a density value of said black and white table according to said inputted designation data.

6. An image processing method comprising:
a table storing step of storing a color table and a black and white table, the color table for converting full-color image data including one lightness value and a plurality of color values into full-color print data including density values of three primary colors and black, the black and white table for converting said full-color image data into black and white print data including a density value of black;
a data input step of inputting said image data;
a table processing step of replacing a density value in at least a part of said three primary colors of said color table with a density value of said black and white table while generating a temporary table by replacing all the density values in other parts of said three primary colors and black with zero;
a table retaining step of temporarily retaining said temporary table;
a data conversion step of converting said inputted image data into said print data using said temporarily-retained temporary table; and
a data output step of outputting said converted print data.

7. An image processing method comprising:
a table storage step of storing a plurality of look-up tables including a color table and a black and white table in a table storage unit;
a table retaining step of temporarily retaining a look-up table for data conversion in a table retaining unit;
a data input step of inputting image data;
a data conversion step of converting said inputted image data into said print data using said temporarily-retained look-up table;
a data output step of outputting said converted print data;
an instruction input step of selectively inputting print instructions for a color image, a black and white image, and a monochrome image; and
a table processing step of obtaining said color table from said table storage unit to store said color table in said table retaining unit in said table retaining step when said print instruction for said color image is inputted, of obtaining said black and white table from said table storage unit to store said black and white table in said table retaining unit in said table retaining step when said print instruction for said black and white image is inputted, and of obtaining said color table and said black and white table from said table storage unit to generate said temporary table and storing said generated temporary table in said table retaining unit in said table retaining step when said print instruction for said monochrome image is inputted.

8. The image processing method according to claim 7, further including a designation input step of inputting designation data of at least a part of said three primary colors, the designation data of at least the part of said three primary colors being replaced with a density value of said black and white table,
wherein, in said table processing step, a density value in at least a part of said three primary colors is replaced with a density value of said black and white table according to said inputted designation data.

9. An image processing apparatus comprising:
a table storage unit in which a color table and a black and white table are stored, the color table for converting full-color image data including one lightness value and a plurality of color values into full-color print data including density values of three primary colors and black, the black and white table for converting said full-color image data into black and white print data including a density value of black;
a data input unit to which said image data is inputted;
a table processing unit which generates a temporary table by replacing density values of three primary colors and black with a density value of a specific color in each said lightness value in one of a color portion where at least one of said plurality of color values of said color table is not zero and a black and white portion where all the color values of said color table are zero;
a table retaining unit which temporarily retains said temporary table;
a data conversion unit which converts said inputted image data into said print data using said temporarily-retained temporary table; and
a data output unit which outputs said converted print data.

10. The image processing apparatus according to claim 9, wherein said table processing unit generates said temporary table by replacing density values of three primary colors and black with a density value of a specific color in each said lightness value in one of said color portion and said black and white portion.

11. The image processing apparatus according to claim 10, wherein said table processing unit generates said temporary table by replacing density values of three primary colors and black with zero in the other of said color portion and said black and white portion.

12. The image processing apparatus according to claim 10, wherein said table processing unit generates said temporary table by replacing density values of three primary colors and black with a density value of a second specific color in each said lightness value in the other of said color portion and said black and white portion.

13. The image processing apparatus according to claim 9, wherein said table processing unit generates said temporary table by replacing density values of three primary colors and black with a density value of a specific color in each said lightness value in both said color portion and said black and white portion.

14. The image processing apparatus according to claim 9, wherein said table processing unit sets a density value of said color table to a density value of said specific color, each of said plurality of color values being constant in the density value of said color table.

15. The image processing apparatus according to claim 9, wherein said table processing unit sets a density value of said color table to a density value of said specific color, the density value of said color table being previously defined around a portion where each of said plurality of color values is constant.

16. The image processing apparatus according to claim 9, wherein said table processing unit generates said temporary table by replacing all the density values of black with zero in a portion which is replaced with a density value of said specific color of said color table.

17. The image processing apparatus according to claim 9, wherein said table processing unit utilizes a density value of said black and white table as a density value of said specific color.

18. An image processing apparatus comprising:
a table storage unit in which a plurality of look-up tables including a color table and a black and white table are stored;
a table retaining unit which temporarily retains a look-up table for data conversion;
a data input unit to which image data is inputted;
a data conversion unit which converts said inputted image data into said print data using said temporarily-retained look-up table;
a data output unit which outputs said converted print data;
an instruction input unit to which at least print instructions for a color image, a black and white image, and a special image are selectively inputted; and
a table processing unit which obtains said color table from said table storage unit to store said color table in said table retaining unit when said print instruction for said color image is inputted, the table processing unit obtaining said black and white table from said table storage unit to store said black and white table in said table retaining unit when said print instruction for said black and white image is inputted, the table processing unit obtaining said color table and said black and white table from said table storage unit to generate said temporary table and storing said generated temporary table in said table retaining unit when said print instruction for said special image is inputted.

19. The image processing apparatus according to claim 18, further including a designation input unit to which designation data of said specific color is inputted,
wherein said table processing unit generates said temporary table with said specific color corresponding to said inputted designation data.

20. An image processing method comprising:
a table storage step of storing a color table and a black and white table, the color table for converting full-color image data including one lightness value and a plurality of color values into full-color print data including density values of three primary colors and black, the black and white table for converting said full-color image data into black and white print data including a density value of black;
a data input step of inputting said image data;
a table processing step of generating a temporary table by replacing density values of three primary colors and black with a density value of a specific color in each said lightness value in one of a color portion where at least one of said plurality of color values of said color table is not zero and a black and white portion where all the color values of said color table are zero;
a table retaining step of temporarily retaining said temporary table;
a data conversion step of converting said inputted image data into said print data using said temporarily-retained temporary table; and
a data output step of outputting said converted print data.

21. An image processing method comprising:
a table storage step of storing a plurality of look-up tables including a color table and a black and white table in a table storage unit;
a table retaining step of temporarily retaining a look-up table for data conversion in a table retaining unit;
a data input step of inputting image data;
a data conversion step of converting said inputted image data into said print data using said temporarily-retained look-up table;
a data output step of outputting said converted print data;
an instruction input step of selectively inputting print instructions for a color image, a black and white image, and a special image; and
a table processing step of obtaining said color table from said table storage unit to store said color table in said table retaining unit in said table retaining step when said print instruction for said color image is inputted; obtaining said black and white table from said table storage unit to store said black and white table in said table retaining unit in said table retaining step when said print instruction for said black and white image is inputted; and obtaining said color table and said black and white table from said table storage unit to generate said temporary table and storing said generated temporary table in said retaining unit in said table retaining step when said print instruction for said special image is inputted.
